(19) United States
(12) Patent Application Publication
(10) Pub. No.: US 2010/0064021 A1
(43) Pub. Date: Mar. 11, 2010

(54) MESSAGE DISPLAY DEVICE AND METHOD

(75) Inventors: Tatsuaki KIDA, Kawasaki (JP); Hisanori Itaya, Kawasaki (JP); Hironaga Okuya, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/551,639

(22) Filed: Sep. 1, 2009

(30) Foreign Application Priority Data
Sep. 5, 2008 (JP) 2008-227806

(51) Int. Cl. G06F 15/16

(52) U.S. Cl. 709/207

(57) ABSTRACT

A message display device for displaying a message used for notifying a user of the device of a state that a function processing included in the device is finished, the message display device includes an activation state storage unit for storing an activated event of a function including a process for displaying the message, and a message display determination unit for controlling the display of the message according to a frequency and an interval that the function including the process for displaying the message is activated.

### CROSS-REFERENCE TO RELATED APPLICATIONS

This application is based upon and claims the benefit of priority of the prior Japanese Patent Application No. 2008-227806, filed on Sep. 5, 2008, the entire contents of which are incorporated herein by reference.

### FIELD

The embodiments discussed herein are related to a message display device and method.

### BACKGROUND

A device has been popularized in which a message for notifying the user of the device of a state of a function being processed by the device is displayed in a device equipped with a display unit such as a mobile phone, a personal computer, or the like.

For example, a mobile phone and a personal computer temporarily display message of “transmitted” under the state where transmission of e-mail is finished in a mail transmission function, a mobile phone temporarily displays message of “registered” under the state where information such as a telephone number, a mail address, or the like is registered in an address book in an address registration function, and a mobile phone and a personal computer temporarily display message of “set” under the state where setting of various setting items is performed in a set registration function.

Further, there is also a device that displays a message of “transmit or not” and asks for response of “OK” or “CANCEL” about the transmission in the case where data owned by the device is transmitted to another device.

There is a case that the displayed message for confirming the processing state is bothersome for the user. Accordingly, it has been examined that a setting not to display the message for asking the response is preliminarily performed to the device as described in Japanese Laid-open Patent Publication No. 2006-5847.

### SUMMARY

According to an aspect of the embodiment, a message display device for displaying a message used for notifying a user of the device of a state that a function processing included in the device is finished, the message display device includes an activation state storage part for storing an activated event of a function including a process for displaying the message, and a message display determination part for controlling the display of the message according to a frequency and an interval that the function including the process for displaying the message is activated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a structure of a mobile phone;

FIG. 2 is a diagram illustrating a processing of message display of the mobile phone;

FIG. 3 is a diagram illustrating an activation state of the message display;

FIG. 4 is a diagram illustrating predetermined data for the message display;

FIG. 5 is a diagram illustrating a processing flow of the message display; and

FIG. 6 is a diagram illustrating a determining flow of the message display.

### DESCRIPTION OF EMBODIMENTS

As described previously, in a device equipped with a display unit such as a mobile phone, a personal computer, or the like, there is a case that a message to notify the user of a processing state of the device for confirmation is displayed. Hereafter the message for confirmation is described as the confirmation message.

The confirmation message provides sense of security to the user who is inexperienced in handling the device, or when a function including a process for displaying the message is used after a long interval.

However, for the user who is experienced in handling the device, there is no trouble even when the confirmation message is not displayed in many cases, and the confirming messages may cause deterioration of operation efficiency.

With reference to drawings, embodiments will be described in detailed below, and the same reference numeral is used to denote the same or similar element in the drawings.

Note that a mobile phone is exemplified as the message display device in the following description. However, the message display device may be a personal computer or the like equipped with a display unit that displays a message used for notifying the user of the processing state of the device for confirming the state of the device.

### First Embodiment

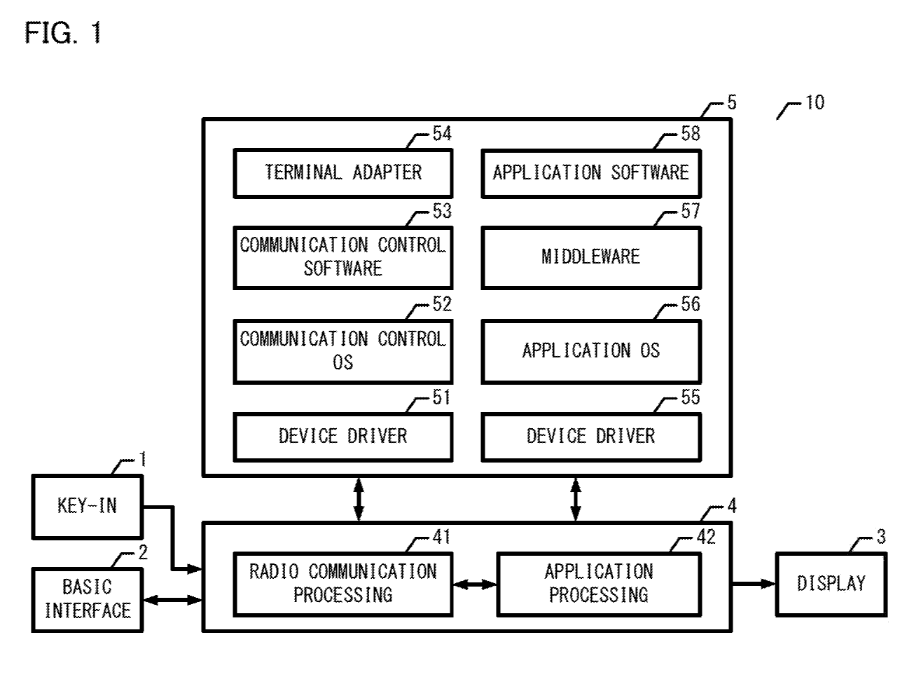

FIG. 1 is a diagram schematically illustrating a structure of a mobile phone. Reference numeral 10 denotes a mobile phone. The mobile phone 10 includes constitutional elements 1 to 5, which will be described herein below.

Reference numeral 1 denotes a key-in unit. The key-in unit 1 generates information (key information) used for identifying a key depressed in accordance with a key (may be called as a button) mounted on the mobile phone 10. The key-in unit 1 includes, for example, an on-hook key, an off-hook key, numeral keys of 0 to 9, a decision key, a clear key, a menu key, and the like.

Reference numeral 2 denotes a basic interface unit. The basic interface unit 2 includes an antenna, a microphone and a loudspeaker, and performs a processing of a signal required for a radio communication processing which is a basic function of the mobile phone 10.

Reference numeral 3 denotes a display unit. The display unit 3 displays characters/letters and figures with which the mobile phone 10 notifies its user of a processing state of the mobile phone 10 and makes the user confirm the processing state. For example, there are numeral key information in case of inputting telephone number, text information to be transmitted in case of transmitting a mail, a transmission completion message in case of a mail being transmitted, and the like.

Reference numeral 4 denotes a device control processing unit. The device control processing unit 4 includes a radio communication processing unit 41 and an application processing unit 42 so as to process and control the key information from the key-in unit 1, information on radio communication with the basic interface unit 2 and information on display on the display unit 3.

The radio communication processing unit 41 is equipped with a CPU (Central Processing Unit) for processing communication and call processing controlling to provide layer 1 function for performing communication and call processing.

The application processing unit 42 is equipped with a CPU taking charge of application processing to perform processing of the key information from the key-in unit 1, processing of information displayed on the display unit 3 and processing for operating application software installed on the mobile phone 10.

The radio communication processing unit 41 and the application processing unit 42 also perform processing of information required for signal transmission/reception from a radio communication function to an application function and vice versa. For example, the radio communication processing unit 41 notifies the application processing unit 42 of the state of communication so as to perform displaying on the display unit 3 in accordance with the communicating state.

Reference numeral 5 denotes a software group. The software group 5 includes pieces of software 51 to 58 which will be described hereinbelow.

A device driver 51 is software used to make use of peripheral devices required to execute the radio communication processing which is a basic function of the mobile phone 10. A communication control OS 52 is an OS (Operating System) prepared for a communication control CPU incorporated into the radio communication processing unit 41. A communication control software 53 is used to perform processing of a communication control (layer 2/layer 3 control) protocol. A terminal adapter 54 is software used to process an interface signal for connecting to a DSU (Digital Service Unit) over ISDN (Integrated Services Digital Network).

A device driver 55 is software used to make use of peripheral devices required for execution of application functions installed on the mobile phone 10. An application OS 56 is an OS prepared for a CPU for application processing incorporated into the application processing unit 42. A middleware 57 is software located in the middle of an OS and application software, such that application software can be run without being affected by the differences of the hardware or the OS. An application software 58 is installed on the mobile phone 10, and includes, for example, mail software used to implement an e-mail, software used to implement a music player, game software used to implement an electronic game, and the like.

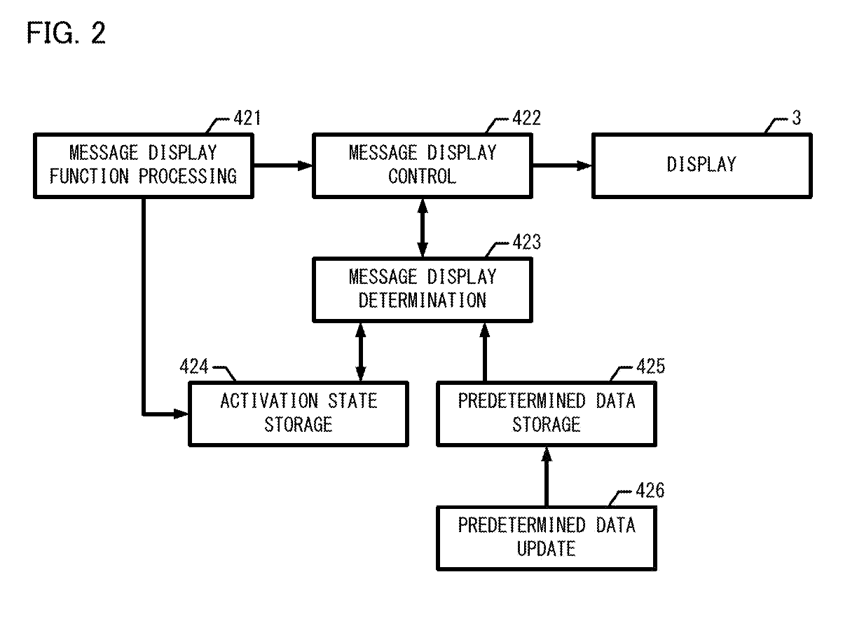

FIG. 2 is a diagram illustrating a processing of message display. A message display function processing part 421, a message display control part 422, a message display determination part 423, an activation state storage part 424, a predetermined data storage part 425, and a predetermined data update part 426 are included in the application processing unit 42 described in FIG. 1. These units process the data to be displayed on the display unit 3.

The message display function processing part 421 processes the display function included in functions including a step of processing the data to be displayed on the display unit 3 in the function being processed by the mobile phone 10, and notifies the message display control part 422 of the data to be displayed. Then, when a function including a process for displaying a confirmation message is processed, data used to identify the function (referred to as message display function name) is notified to the activation state storage part 424. The message display function name is included in the display data and notified also to the message display control part 422.

The confirmation message is a message used for notifying the user of the mobile phone 10 of a function processing to confirm that the function processing is finished when the processing of the function provided in the mobile phone 10 is finished. As examples of the message, there are “mail transmission completed” in the case where a mail transmission processing is normally finished in a mail transmission function, “registered” in the case where an address registration processing is normally finished in an address registration function, and the like. The confirmation message is displayed only for a predetermined period sufficient for the user confirming the message.

The message display control part 422 processes the display data notified from the message display function processing part 421 and controls the display data so as to generate the confirmation message. That is, the message display control part 422 inquires of the message display determination part 423 about the message display function name notified from the message display function processing part 421. Then, based on response data from the message display determination part 423, when the display data notified from the message display function processing part 421 has an attribute non-displaying the confirmation message, the message display control part 422 controls the display data and notifies the display unit 3 of data without non-displaying data, used for displaying.

The message display determination part 423 determines that the appropriate confirmation message inquired by the message display control part 422 is displayed or made non-display, based on the data of an activation frequency and an activation interval stored in the activation state storage part 424 and a predetermined data (predetermined value) stored in the predetermined data storage part 425. The determined result is notified to the message display control part 422 corresponding to the message display function name.

The activation state storage part 424 updates the cumulative activation number and activation frequency for every message display function name based on the data notified (message display function name) when the message display function processing part 421 processes a function including a process for displaying a confirmation message. Further, the activation state storage part 424 obtains the activation interval from the difference between the stored data of the previous activation time and the data of the present activation time, and then updates the activation time. The data of the updated activation frequency and the obtained activation interval is notified to the message determination part 423.

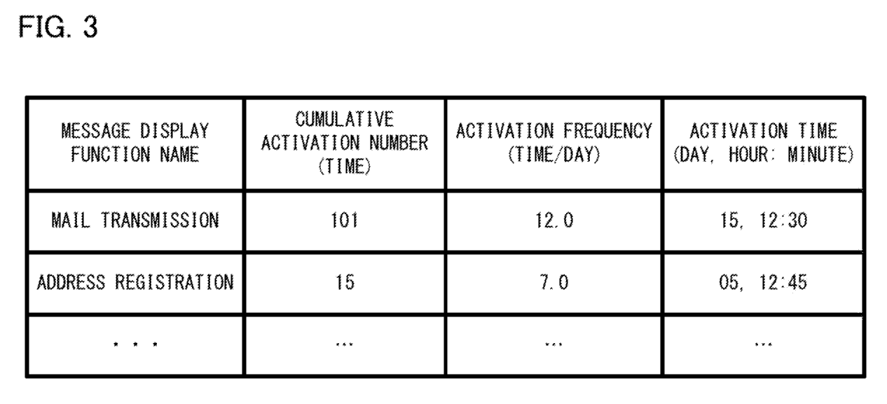

The updated data of the cumulative activation number, the activation frequency, and the activation time is stored for every message display function name as indicated in FIG. 3 described below.

The predetermined data storage part 425 stores a non-display identifier used for identifying whether or not the confirmation message is made non-display and predetermined data that are threshold values used for determining whether or not the confirmation message is made non-display, for example, the cumulative activation number, the activation frequency, and the activation interval, for every message display function name. By the way, there is a case that the cumulative activation number is also used as a determination condition, so that the cumulative activation number is stored as predetermined data.

The predetermined data update part 426 stores the data set by the user for updating in the predetermined data storage part 425 when the data stored in the predetermined data storage part 425 is updated by the user of the mobile phone 10.

By the way, the message display function processing part 421 is used as an example of the first determination means and the fourth determination means, the message display control part 422 is used as an example of the control means, and the message display determination part 423 is used as an example of the second determination means and the third determination means.

FIG. 3 is a diagram illustrating the activation state of the message display, and indicates the data stored in the activation state storage part 424 of FIG. 2.

In the activation state storage part 424, for example, a function including a process for displaying the confirmation message used for such as mail transmission, address registration, or the like is registered, (the function is referred to as message display function name.) and the cumulative activation number, the activation frequency, and the activation time are stored corresponding to the message display function name.

The cumulative activation number indicates an activated cumulative number of the function from the starting of using the device, and is updated for each time when the function including a process for displaying the confirmation message is activated.

The activation frequency indicates the frequency that the function is activated, and the activation frequency is updated for each time when the function including a process for displaying the confirmation message is activated, and the activation frequency in the drawing is reset for every one day.

The activation time indicates the time when the function is activated. An activation interval is calculated based on the data of the activated time and the data of the activation time stored in the activation state storage part 424 for each time when the function including a process for displaying the confirmation message is activated, and the activation interval is notified to the message display determination part 423. And the data of the activated time is updated.

Notably, it is preferable that the data stored herein may be reset by the user of the mobile phone 10.

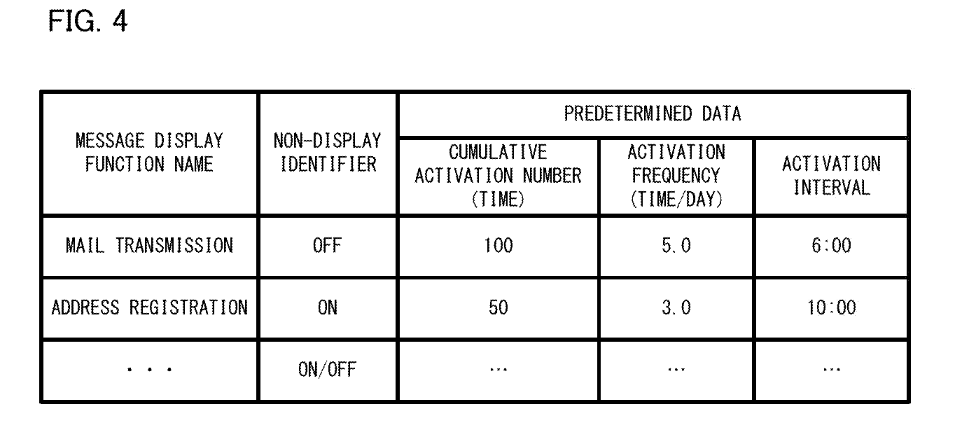

FIG. 4 is a diagram for illustrating a predetermined data of the message display, and indicates the data stored in the predetermined data storage part 425 of FIG. 2.

For example, the message display function name including the confirmation message used for such as mail transmission, address registration, or the like is registered. Further, the non-display identifier, and the predetermined data (predetermined value) of the cumulative activation number, the activation frequency and the activation interval are stored corresponding to the message display function name.

The non-display identifier is an identifier used for setting whether or not the confirmation message is regarded as an object of non-display. For example, in the case of OFF, the confirmation message is not regarded as the object of non-display, and in the case of ON, regarded as the object of non-display.

The minimum values at which the confirmation message is made non-display are set as the predetermined data of the cumulative activation number and the activation frequency.

The maximum interval for activation at which the confirmation message is made non-display is set as the activation interval.

The data stored in the predetermined data storage part 425 are changed based on the data from the predetermined data update part 426.

That is, in the mobile phone 10 described above, when a function including a process for displaying the confirmation message (message display function) is activated, the cumulative activation number, the activation frequency, the activation time are updated and the activation interval is obtained for every message display function name stored in the activation state storage part 424. Then, as for the activation frequency and the activation interval, whether of not the message is made non-display is determined based on the corresponding predetermined data stored in the predetermined data storage part 425. Accordingly, the message display control part 422 controls whether or not the message is made non-display based on the determined result by the message display determination part 423 as for the confirmation message that is an object of non-display.

According to the mobile phone 10 described above, when a function including a process for displaying the confirmation message is activated, it becomes possible to determine whether or not the confirmation message is made non-display based on the predetermined data (predetermined value) of the activation frequency and the activation interval for every function. Accordingly, it becomes possible that the confirmation message is made non-display for every function. Further, it becomes also possible to exclude the confirmation message from the object of non-display for every function.

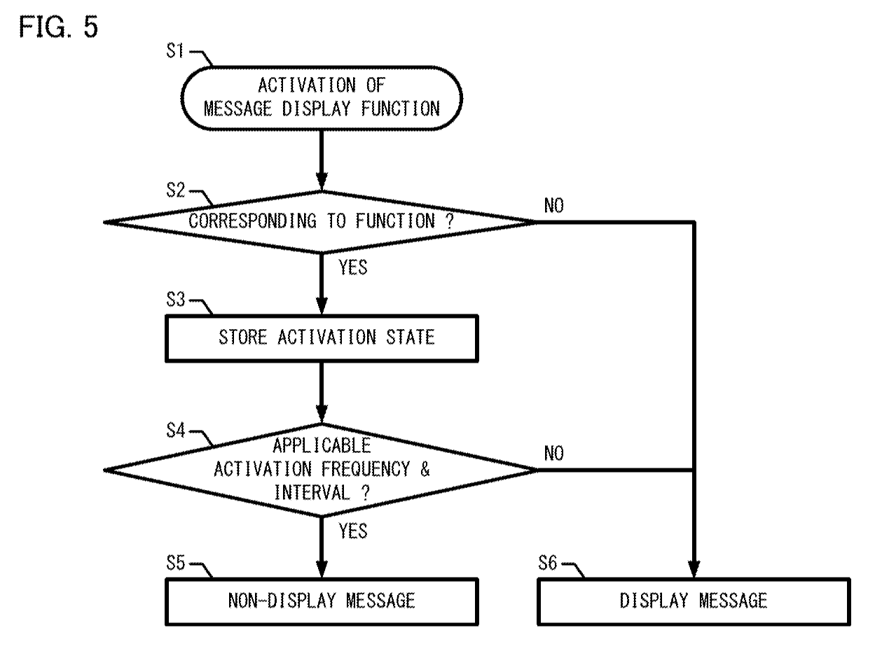

FIG. 5 is a diagram illustrating a processing flow of the message display.

S1: A function including a process for displaying a message such as, for example, a mail transmission function of a mobile phone is activated.

S2: Whether or not the function activated in step S1 is corresponded to a function including a process for displaying the confirmation message used for notifying the user of the processing state of the function (message display function) is determined. The determination is performed by whether or not the function is included in the message display function registered in the predetermined data storage part 425 indicated in FIG. 2.

In the case of corresponding to the function, step S3 is performed, and in the case of an in-corresponding to the function, the processing of step S6 for displaying the message is performed.

S3: The activation state is stored in the case where a function including a process for displaying the confirmation message is activated in step S2. That is, the cumulative activation number of the function and the activation frequency obtained from the cumulative activation number of per unit time are updated for every message display function name, the activation interval is obtained from the time data when the function is activated and the previous time data, and the time data (activation time) is updated.

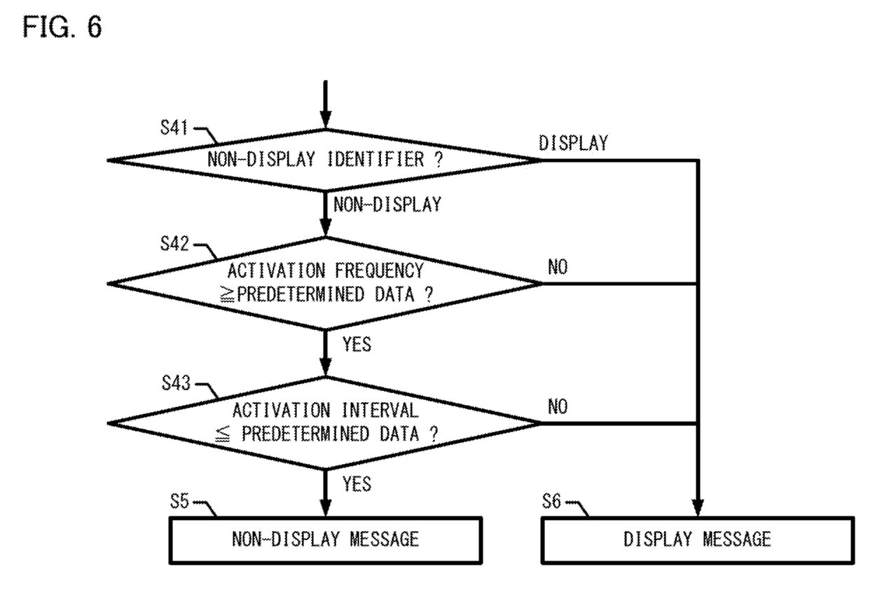

S4: Whether or not the activation frequency updated in step S3 and the activation interval obtained in step S3 are corresponding to the predetermined conditions is determined. A detail processing flow of the step is indicated in FIG. 6.

S5: A message processed in a step for displaying the message is made non-display, in the case where the activation frequency and the activation interval are corresponding to the predetermined conditions in step S4.

S6: A step for displaying the message is performed, in the case where the function is not including a process for displaying the confirmation message in step S2, or in the case where the activation frequency and the activation interval are not corresponding to the predetermined conditions in step S4.

FIG. 6 is a diagram illustrating a determining flow of the message display and indicates contents of the processing of step S4 of FIG. 5.

S41: This step S41 is processed when the activated function includes a process for displaying the confirmation message. Whether or not the confirmation message is made non-display is determined based on the non-display identifier that indicates whether or not the confirmation message is regarded as an object of non-display, and the identifier is stored to correspond to the function.

And, the non-display identifier is stored in the predetermined data storage part 425 indicated in FIG. 2. The message display determination part 423 receives data about the function, that is, the data of the message display function name such as mail transmission, from the message display control part 422. And the message display determination part 423 determines whether or not the appropriate confirmation message is regarded as an object for non-display depending on the non-display identifier corresponding to the message display function name registered in the predetermined data storage part 425.

According to the determined result, in the case where the confirmation message is the object of non-display, step S42 is processed, and in the case where the message is the object of display, step S6 is processed.

S42: This step S42 is processed when the function including a process for displaying the confirmation message is the object that is made non-display in step S41. It is determined whether or not the activated frequency (activation frequency) of the function is greater than or equal to the predetermined data (predetermined value).

That is, the message display determination part 423 reads the data about the activation frequency corresponding to the appropriate message display function name from the activation state storage part 424, reads the data about the predetermined data corresponding thereto from the predetermined data storage part 425, and determines whether or not the activation frequency is greater than or equal to the predetermined data (predetermined value).

By the way, according to the appropriate function, the determination may be preformed based on the cumulative activation number instead of the activation frequency.

According to the determined result, when the activation frequency is greater than or equal to the predetermined data, step S43 is processed, and when smaller than the predetermined data, step S6 is processed.

S43: This step S43 is processed when the activation frequency of the function including a process of displaying the confirmation message is greater than or equal to the predetermined data in step S42. It is determined whether or not the interval of the activated function (activation interval) is smaller than or equal to the predetermined data.

That is, the message display determination part 423 determines whether or not the activation interval is smaller than or equal to the predetermined data (predetermined value) based on the data of the activation interval corresponding to the appropriate message display function name and the predetermined data read from the predetermined data storage part 425.

According to the determined result, when the activation interval is smaller than or equal to the predetermined data, the message display control part 422 performs controlling so that the confirmation message is made non-display in step S5, and when the activation interval is larger than the predetermined data, the message display control part 422 performs controlling so that the confirmation message is displayed in step S6.

According to the embodiment, when a function including a process for displaying the confirmation message is activated, whether or not the confirmation message is the object of non-display is determined for every function. Only when the object of non-display is determined, whether or not the activation frequency of the function is greater than or equal to the predetermined data (predetermined value) is determined, and only when the activation frequency is greater than or equal to the predetermined data, whether or not the activation interval of the function is smaller than or equal to the predetermined data (predetermined value) is determined. And it becomes possible that the confirmation message is made non-display when the activation interval is smaller than or equal to the predetermined data. Further, the aforementioned processing is performed at each time when the function including a process of displaying the confirmation message is activated, so that the confirmation message is to be displayed when the function has not been used for a while.

Further, since the predetermined data (predetermined values) are changed by the user, it is possible to control to be performed in accordance with the individuality of the user such as inexperience operational of the user.

### Second Embodiment

In the first embodiment, the aforementioned illustration is described for the mobile phone as an example of the message display device.

In the second embodiment, a personal computer is exemplified as the message display device. For example, the structure except the basic interface unit 2, the radio communication processing unit 41 and the software excluded reference numeral 51 to 54 in the software group 5 is regarded as a structure of the personal computer. Accordingly, the embodiment described in detail as the first embodiment is possible to be provided by the personal computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A message display device for displaying a message used for notifying a user of the device of a state that a function processing included in the device is finished, the message display device comprising:
an activation state storage part for storing an activated event of a function including a process for displaying the message; and
a message display determination part for controlling the display of the message according to a frequency and an interval that the function including the process for displaying the message is activated.

2. A message display device for displaying a message used for notifying a user of the device of a state that a function processing included in the device is finished, the message display device comprising:
first determination means for determining that a function including a process for displaying the message is activated;
second determination means for determining that a frequency that the function including the process for displaying the message is activated is greater than or equal to a first predetermined value according to a determination result of the first determination means;
third determination means for determining that an interval that the function including the process for displaying the message is activated is smaller than or equal to a second predetermined value according to a determination result of the first determination means; and
control means for controlling to restrain displaying of the message when the frequency is greater than or equal to a first predetermined value and the interval is smaller than or equal to a second predetermined value.

3. The message display device according to claim 2, further comprising:
fourth determination means for determining that the function including the process for displaying the message is activated on the basis of an identifier set whether the message is displayed or not; and
control means for controlling to restrain displaying of the message when the frequency is greater than or equal to a first predetermined value, the interval is smaller than or equal to a second predetermined value, and the identifier is set that the message is not displayed.

4. The message display device according to claim 2, further comprising:
means for setting the first predetermined value; and
means for setting the second predetermined value.

5. The message display device according to claim 3, further comprising means for setting the identifier whether the message is displayed or not.

6. The message display device according to claim 1, wherein the message display device is a mobile phone.

7. The message display device according to claim 2, wherein the message display device is a mobile phone.

8. A message display method for notifying a user of the device of a state that a function processing included in a message display device is finished, the message display method comprising:
determining that a function including a process for displaying the message is activated;
determining that a frequency that the function including the process for displaying the message is activated is greater than or equal to a first predetermined value according to a determination result of that the function including the process for displaying the message is activated;
determining that an interval that the function including the process for displaying the message is activated is smaller than or equal to a second predetermined value according to a determination result of that the function including the process for displaying the message is activated; and
controlling to restrain displaying of the message when the frequency is greater than or equal to a first predetermined value and the interval is smaller than or equal to a second predetermined value.

9. The message display method according to claim 8, further comprising:
determining that the function including the process for displaying the message is activated on the basis of an identifier set whether the message is displayed or not; and
controlling to restrain displaying of the message when the frequency is greater than or equal to a first predetermined value, the interval is smaller than or equal to a second predetermined value, and the identifier is set that the message is not displayed.

10. The message display method according to claim 8, wherein the user changes the first predetermined value and/or the second predetermined value as occasion demands.

11. The message display method according to claim 9, wherein the user sets the identifier whether the message is displayed or not as occasion demands.

12. The message display method according to claim 8, wherein the method is a display method of a mobile phone.
